(19) United States
(12) Patent Application Publication
(10) Pub. No.: US 2026/0091900 A1
(43) Pub. Date: Apr. 2, 2026

(54) HEATING DEVICE

(71) Applicant: Uhlmann Pac-Systeme GmbH & Co. KG, Laupheim (DE)

(72) Inventors: Yannick NIEDERBACHER, Laupheim (DE); Wolfgang KRAHL, Laupheim (DE)

(21) Appl. No.: 19/348,026

(22) Filed: Oct. 2, 2025

(30) Foreign Application Priority Data
Oct. 2, 2024 (EP) 24204296.8

(51) Int. Cl. B65B 51/12; B30B 15/06

(52) U.S. Cl. CPC B65B 51/12; B30B 15/064

(57) ABSTRACT

A heating device for heating a forming film has a first tool with a first heating plate, which is mounted by way of a plurality of first spring elements, and a second tool with a second heating plate, which is mounted by way of a plurality of second spring elements. The spring elements of the plurality of first spring elements and of the plurality of second spring elements are spaced apart from each other in at least one direction perpendicular to their spring axis.

### CROSS-REFERENCE TO RELATED APPLICATIONS

This application claims the benefit of and priority under 35 U.S.C. § 119 to European Patent Application No. 24 204 296.8 filed Oct. 2, 2024, the contents of which is incorporated herein by reference in its entirety.

### FIELD

The present disclosure relates to a heating device for heating a forming film, a packaging machine comprising such a heating device as well as a method for operating such a packaging machine.

### BACKGROUND

Packaging machines for packaging products are known, in which cavities are initially molded into a forming film, which cavities are subsequently filled with products and closed by means of a cover film. The resulting packages are also referred to as blister packs and the packaging machine is thus referred to as a blister machine. Such packaging machines may comprise a heating device in order to heat the forming film to a desired forming temperature before a molding device molds the cavities into the forming film. In one type, the heating device comprises two plate-shaped tools, which each have a heating plate, and the forming film is guided through between these two tools in a clocked manner. When the tools are closed, the heating plates contact the forming film and heat the latter to the desired temperature. It has become clear that the heating plates can have production- and/or assembly-related unevennesses. These can be local unevennesses or, for example, bent open regions of the heating plates in edge areas, wherein a gap can be formed between the heating plates in the region of these unevennesses. Said unevennesses thus result in that a full-faced contact of the heating plates to the forming film cannot be established, which, in turn, results in an uneven heat introduction into the forming film. The uneven temperature distribution in the forming film resulting therefrom can have a disadvantageous effect on the subsequent molding process as well as on the quality of the forming film and of the created cavities because, e.g., the forming temperature is not reliably reached in the entire format range.

### SUMMARY

The present disclosure provides a heating device for heating a forming film, which provides for an even and precise heating of the forming film in a simple and cost-efficient manner.

According to an aspect of the present disclosure, a heating device for heating a forming film comprises a first tool and a second tool. The first tool comprises a first mount and a first heating plate, which is mounted on the first mount by means of a plurality of first spring elements. The second tool comprises a second mount and a second heating plate, which is mounted on the second mount by means of a plurality of second spring elements. The spring elements of the plurality of first spring elements and of the plurality of second spring elements each have a spring axis and are spaced apart from each other in at least one direction perpendicular to the spring axis.

In this way, a heating device is provided, in which the first and the second heating plate are mounted by means of spring elements, which are spaced apart from each other, whereby, in a closed state of the first tool and of the second tool, the spring forces of the plurality of first spring elements and of the plurality of second spring elements do not cancel each other out but can act on the heating plates and deform them elastically. Due to the elastic deformation, the first heating plate and the second heating plate adapt to one another, thereby compensating unevennesses and tolerances and establishing a full-faced contact to the forming film. An even and precise heating of the forming film is thus facilitated, without significantly increasing the efforts and costs of production and assembly of the heating plates.

The plurality of first spring elements and the plurality of second spring elements are preferably formed and arranged in such a way that the first heating plate and/or the second heating plate are elastically deformed in the closed state of the first and of the second tool. The above-described even and precise heating can thus be attained very easily by means of a suitable selection and positioning of the spring elements.

The formation and arrangement of the plurality of first spring elements and the plurality of second spring elements depend, for example, on the stiffness of the first heating plate and of the second heating plate and, thus, substantially on the material and thickness thereof. A person skilled in the art can select and position suitable spring elements without large effort in order to cause an elastic deformation of the heating plates depending on the formation of the heating plates.

Each first spring element of the plurality of first spring elements is preferably spaced apart from each second spring element of the plurality of second spring elements. In other words, all spring elements are spaced apart from each other in the direction perpendicular to their spring axis, and no pair of spring axes of a first spring element and of a second spring element is aligned coaxially. All spring elements of the plurality of first and second spring elements thus contribute to achieving the desired effect. The spring axes of all spring elements of the plurality of first and second spring elements are preferably orientated parallel to each another.

The first tool and the second tool can be arranged one on top of the other, wherein the first tool may then represent an upper tool and the second tool may represent a lower tool. The forming film then extends between the first and the second tool in a substantially horizontal direction. However, the first tool and the second tool may also be arranged next to each other, so that the forming film extends essentially vertically or obliquely between the first and the second tool with a vertical component.

The first tool and the second tool can preferably be moved relative to each other in a stroke direction, in particular between an open state and a closed state. In the open state, the forming film can be inserted into an intermediate space between the first heating plate and the second heating plate and can be guided through between them. In the closed state, the first heating plate and the second heating plate contact the forming film arranged between them. The heating device may comprise at least one drive for moving the first tool and/or the second tool parallel to the stroke direction. In a preferred embodiment, a first drive for moving the first tool parallel to the stroke direction is provided and the second tool is arranged in a stationary manner. However, a first drive for moving the first tool and a second drive for moving the second tool can also be provided.

A conveying direction, in which the forming film can be moved through the heating device, is defined in the heating device. The conveying direction is preferably arranged perpendicular to the stroke direction. A transverse direction may be defined perpendicular to the conveying direction and to the stroke direction. The forming film extends essentially in a plane, which is defined by the conveying direction and the transverse direction. The spring elements of the plurality of first and second spring elements are preferably spaced apart from each other at least in the conveying direction and/or the transverse direction.

The plurality of first spring elements and the plurality of second spring elements preferably support the first heating plate and the second heating plate so as to be movable in a direction parallel to the spring axes. The spring axes of the plurality of first and second spring elements are preferably arranged parallel to the stroke direction. The first heating plate and the second heating plate can thus spring back when they meet upon the reception of the forming film between them. The first heating plate and the second heating plate are preferably mounted exclusively resiliently. The first heating plate and the second heating plate can be arranged at a distance from the first mount or from the second mount, respectively, in order to provide for a spring back as well as the elastic deformation of the heating plates.

The plurality of first spring elements and the plurality of second spring elements is preferably arranged in a predetermined arrangement. This arrangement can be determined as a function of the unevennesses or tolerances, respectively, which are to be expected, or as a function of the desired elastic deformation of the heating plates. For example, more spring elements can be provided in regions where stronger unevennesses are to be expected, than in regions where smaller or no unevennesses are to be expected. Alternatively, an even distribution of the spring elements may be selected, for example, in order to effect an even elastic deformation of the heating plates.

In order to describe the arrangement of the plurality of first spring elements and of the plurality of second spring elements, the plurality of first and second spring elements is advantageously viewed in a top view or in a projection into a projection plane, respectively, to which the spring axes are orientated perpendicularly.

In a preferred embodiment, the spring elements of the plurality of first spring elements and of the plurality of second spring elements are arranged along at least one straight line, preferably along a plurality of straight lines. The straight line preferably lies in the projection plane. The spring axes of all spring elements, which are arranged along a respective straight line, intersect this straight line.

The at least one straight line may be orientated parallel to the conveying direction, parallel to the transverse direction or obliquely to the conveying direction. If a plurality of straight lines is provided, these lines are preferably parallel to each other. The spring elements arranged along the same straight line are preferably arranged at regular intervals, so that the spring forces act evenly on the heating plates, which therefore evenly heat the forming film. However, the spring elements may also be arranged at irregular intervals.

In an alternative embodiment, the spring elements of the plurality of first spring elements and of the plurality of second spring elements are arranged along at least one circular line, preferably along a plurality of circular lines. The circular line preferably lies in the projection plane. The spring axes of all spring elements arranged on a respective circular line intersect the circular line. If a plurality of circular lines is provided, said lines are preferably arranged concentrically to with each other. The spring elements are arranged along the same circular line are preferably arranged at regular intervals. However, the spring elements may also be arranged at irregular intervals.

It is also conceivable to combine different ones of the above-described arrangements, such as, for example, straight lines extending in different directions and/or straight lines and circular lines. It is likewise conceivable to arrange the spring elements of the plurality of first spring elements and of the plurality of second spring elements along at least one line, which has a different shape, such as, for example, a curved, ellipsoidal or sinusoidal course.

It is generally advantageous when a first spring element and a second spring element are always provided alternately. A second spring element would accordingly be closest to each first spring element and vice versa. Particularly preferably, a first spring element of the plurality of first spring elements and a second spring element of the plurality of second spring elements are arranged alternately along each line, irrespective of their shape. The first heating plate and the second heating plate can thus be elastically deformed and brought into full-faced contact with the forming film, without a particularly large deformation being required in certain regions. On the contrary, a plurality of opposite deformations is effected, which can be realized easily.

The plurality of first spring elements preferably comprises between 2 and 30 first spring elements, more preferably between 5 and 25 first spring elements, even more preferably between 10 and 20 first spring elements. The plurality of second spring elements preferably comprises between 2 and 30 second spring elements, more preferably between 5 and 25 second spring elements, even more preferably between 10 and 20 second spring elements. It has become clear that in the case of common formats of heating plates, in particular in blister machines, said number of spring elements effects a sufficient elastic deformation in order to compensate for the arising unevennesses and in order to provide for a flat abutment against the forming film.

All types of spring elements and elastic elements, which are known to the person skilled in the art and which are suitable for mounting the first heating plate on the first mount and the second heating plate on the second mount, may generally be considered for the plurality of first spring elements and the plurality of second spring elements. For example, these can be leaf springs, torsion springs, in particular helical springs, disk springs, rubber springs, air springs or gas compression springs. Advantageously, the plurality of first spring elements and the plurality of second spring elements generate a spring force in a direction parallel to the spring axis.

In general, the plurality of first spring elements and the plurality of second spring elements are preferably formed by compression springs. A particularly simple and cost-efficient setup can be achieved when the plurality of first spring elements and the plurality of second spring elements are each formed by helical springs, in particular made of stainless steel. For mounting the heating plates, it is further advantageous when the plurality of first spring elements and the plurality of second spring elements can be compressed in a direction parallel to the spring axis, as it is the case, for example, with the mentioned spring elements.

It has further become clear that the desired elastic deformation can already occur when the spring elements of the plurality of first and second spring elements each have a maximum force, which is preferably between 5 N and 25 N, more preferably between 10 N and 20 N. A spring rate of the spring elements of the plurality of first and second spring elements can be between 1 N/mm and 10 N/mm, more preferably between 2 N/mm and 5 N/mm. In view of the available freedom of movement of the heating plates, a sufficient spring force can thus be attained.

In order to provide for the best possible heat transfer to the forming film and to simultaneously provide for the spring-loaded mounting, the first heating plate preferably comprises at least one first transfer element for contacting the forming film and at least one first heater or heating means for heating the at least one first transfer element, and the second heating plate preferably comprises a second transfer element for contacting the forming film and at least one second heater or heating means for heating the at least one second transfer element.

The at least one first transfer element and the at least one second transfer element preferably each have a plate-shaped design with a working surface, which faces the respective other one of the first and of the second transfer element. A full-faced contact of the first transfer element and of the second transfer element with the forming film is thus facilitated. The working surface of the at least one first transfer element and the working surface of the at least one second transfer element delimit the intermediate space between the first tool and the second tool.

The at least one first heater is preferably arranged on a rear side of the at least one first transfer element, which lies opposite the working surface of the at least one first transfer element and is preferably in direct contact with the at least one first transfer element. The at least one second heater is preferably arranged on a rear side of the at least one second transfer element, which lies opposite the working surface of the at least one second transfer element and is preferably in direct contact with the at least one second transfer element. The first heater and the second heater can thus be arranged as close as possible to the respective transfer element or the working surface, respectively, in order to provide for a heat transfer, which is quick and as loss-free as possible.

The best possible heat transfer and, simultaneously, sufficiently good deformability is preferably attained in that the at least one first transfer element and the at least one second transfer element comprise a metal plate. The metal plate is preferably made of aluminum or an aluminum alloy, but other metals are also possible. The first transfer element and the second transfer element may further have a coating.

In a preferred embodiment, the at least one first transfer element and the at least one second transfer element each have a thickness, which is between 1 mm and 15 mm, more preferably between 2 mm and 10 mm, even more preferably between 2 mm and 6 mm or between 2 mm and 4 mm. The thinner the at least one first transfer element and the at least one second transfer element, the better they can be elastically deformed by means of the spring elements.

The first heater and the second heater may each comprise a heating element in the form of a mica sheet, a silicone or a thick-film heating element. These are particularly well suited because within a small installation space sufficient heating power can be provided.

It is furthermore advantageous when the first heating plate and/or the second heating plate comprises a plurality of segments. In particular, the first and/or the second heating plate may be physically divided into the plurality of segments in this case. Particularly preferably, the first heating plate then comprises a plurality of first transfer elements and the second heating plate comprises a plurality of second transfer elements, preferably corresponding to the number of segments, respectively. Manufacturing tolerances can be reduced, and flexible and thus easily deformable heating plate segments can be formed by means of the division into segments. The segments of the plurality of segments are preferably arranged one behind the other in the conveying direction.

In the case of common formats of heating plates, in particular in blister machines, a number of 2 to 5, preferably of 3 or 4 segments, has turned out to be suitable. For each segment of the plurality of segments, 2 to 8 spring elements, preferably 4 to 5 spring elements, may generally be provided.

Each segment of the plurality of segments of the first heating plate and/or of the second heating plate may have one first or second heating means, respectively. Additionally or alternatively, several heating means may be arranged next to each other in the transverse direction, for example, in order to heat regions of different widths of the first heating plate and of the second heating plate depending on the width of the forming film.

Preferably, the first mount and the second mount comprise a thermal insulator adjacent to the first or second heating plate, respectively, or are made of a thermally insulating material in this region. The generated heat can thus be emitted to the largest possible extent in the direction of the transfer elements and thus in the direction of the forming film.

Preferably, the first heating plate is resiliently mounted exclusively on the first mount and the second heating plate is resiliently mounted exclusively on the second mount. For this purpose, the first mount may have a plurality of first recesses, wherein one spring element of the plurality of first spring elements is at least partly received in each of the plurality of first recesses, and the first heating plate may comprise a plurality of first receiving elements, wherein one spring element of the plurality of first spring elements is mounted on each of the plurality of first receiving elements. The second mount may accordingly have a plurality of second recesses, wherein one spring element of the plurality of second spring elements is at least partly received in each of the plurality of second recesses, and the second heating plate may comprise a plurality of second receiving elements, wherein one spring element of the plurality of second spring elements is mounted on each of the plurality of second receiving means. In this way, the spring-loaded mounting of the first heating plate and of the second heating plate can be implemented particularly easily and cost-efficiently.

The receiving elements of the plurality of first receiving elements and of the plurality of second receiving elements may each be formed by means of a bolt or pin or other threaded connector or friction fit connector, be formed integrally with the respective heating plate or separately, and be connected, for example, to the respective heating plate, in particular screw-connected. Preferably, the plurality of first receiving elements is arranged coaxially to the plurality of first recesses and the plurality of second receiving elements is arranged coaxially to the plurality of second recesses. The plurality of first and second spring elements may be mounted directly, or by means of a sleeve or the like, on the plurality of first or second receiving elements, respectively.

A packaging machine according to an aspect of the present present disclosure comprises the heating device. All features of the heating device described herein in connection with the packaging machine can also be transferred to the heating device as such and vice versa.

Particularly preferably, the packaging machine is a blister machine for producing blister packs. The forming film is preferably a plastic film, in particular made of polypropylene. Such films can be comparatively thick, so that a targeted heat input as well as a sufficient heating are particularly important.

Preferably, the packaging machine furthermore comprises a molding device for molding cavities into the forming film, which is arranged downstream of the heating device in the conveying direction, and a filling device for filling products into the cavities. The products may, in particular, be ingestible medical or pharmaceutical products, food or dietary supplements in the form of tablets, capsules, dragées or the like. Alternatively, the products may be medical products or devices, respectively, such as syringes or injectors, or containers, such as flasks, vials, cartridges or the like. However, cosmetic products or the containers thereof, respectively, or consumables are likewise conceivable.

The packaging machine may furthermore comprise a closing device for closing the cavities, which is preferably formed as a sealing device for sealing a cover film to the forming film. The packaging machine may furthermore comprise a separating device, in particular a punching device, for separating multiple packages from the combination of forming film and cover film.

A method for operating such a packaging machine preferably comprises the following steps: arranging a section of the forming film between the first tool and the second tool in the open state of the first tool and of the second tool; moving the first tool and the second tool relative to one another into the closed state, in which the first tool and the second tool contact the section of the forming film, wherein the first heating plate and the second heating plate are elastically deformed; moving the first tool and the second tool relative to one another back into the open state.

Due to the fact that the first tool and the second tool are advanced in such a way that an elastic deformation of the first and of the second heating plate occurs, the first heating plate and the second heating plate adapt to one another, thereby compensating unevennesses and tolerances and establishing a full-faced contact to the forming film. An even and precise heating of the forming film is thus facilitated, without significantly increasing the efforts and costs of production and assembly of the heating plates.

Moving the first tool and the second tool relative to one another into the closed state may comprise moving the first and/or the second tool, in particular by means of the first or second drive, respectively. In a preferred embodiment, the first tool is moved parallel to the stroke direction, while the second tool is arranged in a stationary manner. When the first heating plate impacts the section of the forming film and the second heating plate, the first heating plate and the second heating plate spring back. The first tool is preferably moved further parallel to the stroke direction, wherein a force for the elastic deformation of the first and of the second heating plate is generated. The full-faced contact to the forming film is then established and the latter is heated. The heating device can subsequently be opened, preferably by moving the first tool parallel to the stroke direction.

All of the features of the heating device and of the packaging machine, which are described herein in connection with the method, can also be transferred to the heating device or packaging machine as such, respectively, and vice versa.

### BRIEF DESCRIPTION OF THE DRAWINGS

FIG. 1 is a schematic illustration of a packaging machine.

FIG. 2 is a schematic illustration of a heating device.

FIG. 3 is a schematic illustration of components of a heating device in an open state.

FIG. 4 is a schematic illustration of the heating device of FIG. 3 in a closed state.

FIG. 5a-d show different variations of exemplary arrangements of spring elements of the heating device.

### DETAILED DESCRIPTION

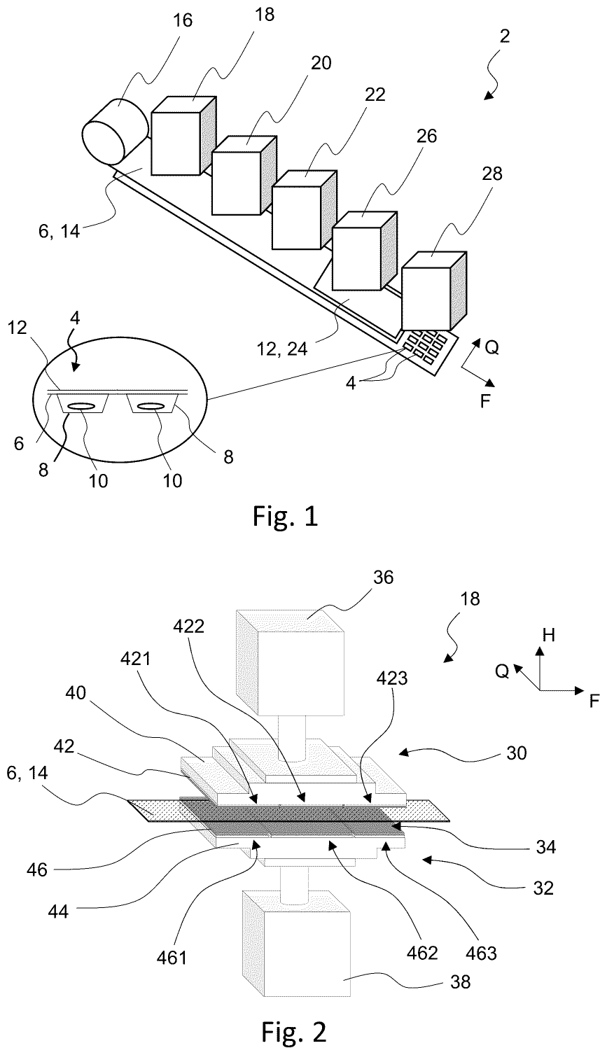

FIG. 1 schematically shows a packaging machine 2 for producing packages 4 in a perspective view as well as a package 4 in a detailed view. The packaging machine 2 is preferably a blister machine and the produced packages 4 are preferably blister packs. Each package 4 comprises at least one product receptacle 8 in the form of a cavity for receiving products 10 formed in the forming film 6. Exactly one product 10 is preferably received in each product receptacle 8, wherein the product 10 can in particular be an ingestible medical or pharmaceutical product, a food product or dietary supplement in the form of a tablet, a capsule, a dragée or the like. A cover film 12 can be sealed to the forming film 6 in order to close the product receptacles 8.

In the illustrated embodiment of the packaging machine 2, the latter has a plurality of processing stations or devices, respectively, as described in more detail below. It goes without saying, however, that the present disclosure is not limited to a certain packaging machine or blister machine, respectively.

The forming film 6 can be a thermoplastic film, in which the product receptacles 8 are created by means of thermoforming. The forming film 6 can be provided as forming film web 14, preferably on a storage roll 16. The packaging machine 2 comprises a heating device 18 for heating the forming film 6 or forming film web 14, respectively, as well as a molding device 20 for molding the product receptacles 8 into the forming film 6 or forming film web 14, respectively. The products 10 can be fed to the product receptacles 8 and inserted into them in a filling device 22. The product receptacles 8 can subsequently be closed, preferably by means of sealing a cover film web 24 to the forming film web 14 in a sealing device 26 of the packaging machine 2. The cover film 12 is thus provided in the form of the cover film web 24, preferably likewise on a storage roll (not shown), which is fed to the forming film web 14 from above.

The packaging machine 2 furthermore comprises a separating device 28 for separating individual packages 4 from the forming film web 14 or from the combination of the forming film web 14 and the cover film 24, respectively. The separating device 28 is preferably formed as a punching device. Downstream of the separating device 28, the packages 4 are present in a separated manner and can be fed to further processing steps by means of a transfer device (not shown), such as, for example, so-called pickers.

The forming film 6 or the forming film web 14, respectively, passes through the packaging machine 2 and in particular the heating device 18 in a conveying direction F. A transverse direction Q is defined perpendicularly to the conveying direction F. A plane defined by the conveying direction F and the transverse direction Q can also be referred to as a working plane, in which the forming film web 14 is arranged and processed by means of the devices 18, 20, 22, 26, 28 of the packaging machine 2.

A heating device 18, as it can be used in the packaging machine 2, is illustrated in more detail in FIG. 2. The heating device 18 comprises a first tool 30 and a second tool 32. In FIG. 2, the first tool 30 and the second tool 32 are in an open state, in which an intermediate space 34 is formed between the first tool 30 and the second tool 32, through which intermediate space 34 the forming film 6 is guided in form of forming film web 14. The forming film web 14 is preferably moved in the conveying direction F in a clocked manner, so that a section of the forming film web 14 is arranged in the heating device 18 in each cycle. The first fool 30 and the second tool 32 can be moved relative to one another in a stroke direction H between the open state and a closed state, in which the first tool 30 and the second tool 32 contact the forming film 6. The heating device 18 preferably comprises a drive 36, 38 for moving one of the two tools 30, 32, in particular a first drive 36 for moving the first tool 30. As illustrated, the heating device 18 may also comprise the first drive 36 for the first tool 30 and a second drive 38 for the second tool 32 for moving the first tool 30 and the second tool 32 parallel to the stroke direction H.

The first tool 30 comprises a first mount 40 and a first heating plate 42, which is mounted on the first mount 40, and the second tool 32 comprises a second mount 44 and a second heating plate 46, which is mounted on the second mount 44. The first heating plate 42 and the second heating plate 46 delimit the intermediate space 34 between the first tool 30 and the second tool 32 and face the forming film 6. In the closed state of the first tool 30 and of the second tool 32, the first heating plate 42 contacts a top side of the forming film 6 and the second heating plate 46 contacts a bottom side of the forming film 6.

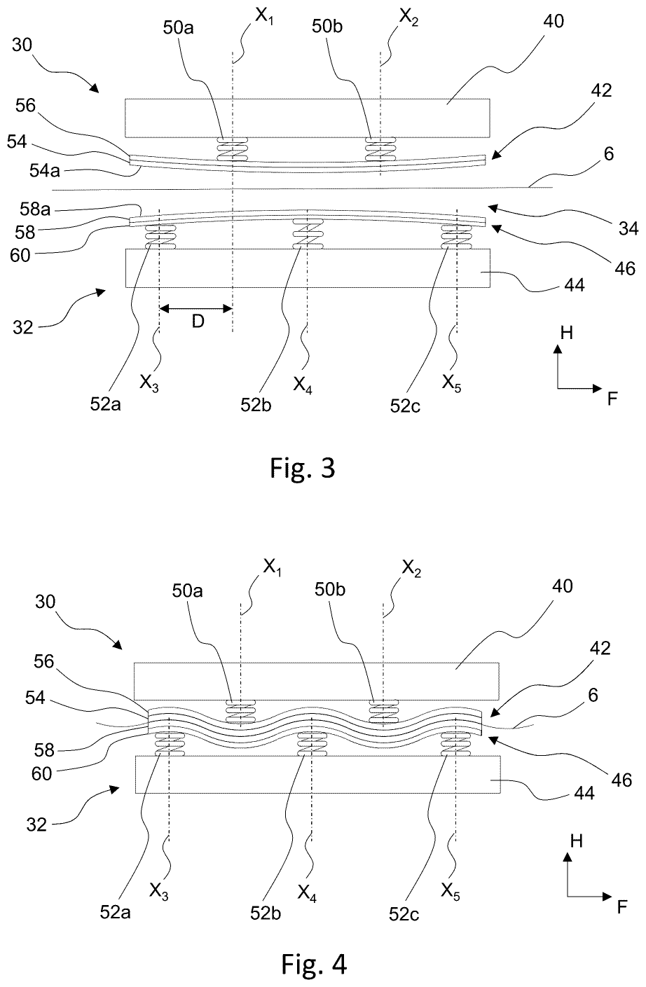

The first tool 30 and the second tool 32 are illustrated schematically in a side view in FIG. 3. The heating plates 42, 46 can generally have production- and/or assembly-related unevennesses, as indicated in an exemplary manner in FIG. 3 by means of a curvature of the heating plates 42, 46. The deformation of the heating plates 42, 46 creating the unevenness is illustrated in the figure in an exaggerated manner for illustration purposes, but may well be between 0.1 mm and 1 mm, in particular between 0.2 mm and 0.5 mm for each heating plate 42, 46, can thus lead to a gap of between 0.5 mm and 1 mm between the heating plates 42, 46 in the closed state. As a result, the first heating plate 42 and the second heating plate 46 would not contact the forming film 6 in a full faced manner when the first tool 30 and the second tool 32 are moved into the closed position. The uneven temperature distribution in the forming film 6 caused thereby can have a negative effect on the subsequent molding process and on the quality of the forming film 6 as well as of the created cavities 8.

The first heating plate 42 is therefore mounted on the first mount 40 by means of a plurality of first spring elements 50a, 50b and the second heating plate 46 is mounted on the second mount 44 by means of a plurality of second spring elements 52a, 52b, 52c, wherein the spring elements of the plurality of first spring elements 50a, 50b and of the plurality of second spring elements 52a, 52b, 52c are arranged spaced apart from each other in a direction perpendicular to their spring axis Xi. The direction perpendicular to the spring axis Xi is particularly preferably parallel to the plane defined by the conveying direction F and the transverse direction Q. The spring axes Xi of adjacent spring elements 50a, 50b, 52a, 52b, 52c are thus arranged spaced apart from one another in the conveying direction F and/or in the transverse direction Q, as indicated by the distance D between the spring axis X1 of the first spring element 50a and the spring axis X2 of the second spring element 52a.

The offset arrangement results in that the spring forces of the plurality of first spring elements 50a, 50b and the spring forces of the plurality of second spring elements 52a, 52b, 52c do not cancel each other out but provide for a deformation of the first heating plate 42 and of the second heating plate 46. The plurality of first spring elements 50a, 50b and the plurality of second spring elements 52a, 52b, 52c are preferably formed and arranged in such a way that the first heating plate 42 and the second heating plate 46 are elastically deformed in the closed state of the first and the second tool 30, 32, as illustrated schematically in FIG. 4. For better illustration, the deformation of the heating plates 42, 46 is also illustrated in an exaggerated manner in FIG. 4.

It can be seen that a full-faced contact of the first heating plate 42 and the second heating plate 46 with the forming film 6 is achieved in the closed state (see FIG. 4) in spite of the unevennesses of the first heating plate 42 and of the second heating plate 46 present in the open state of the first and the second tool 30, 32 (see FIG. 3), so that a targeted and even heat introduction into the forming film 6 is possible.

As can be seen in FIGS. 3 and 4, each spring element of the plurality of first spring elements 50a, 50b is preferably arranged offset from each spring element of the plurality of second spring elements 52a, 52b, 52c, and no pair of a first spring element 50a, 50b and a second spring element 52a, 52b, 52c is aligned coaxially, so that all spring elements contribute to the desired deformation.

The plurality of first spring elements 50a, 50b and the plurality of second spring elements 52a, 52b, 52c are preferably compression springs, which can be compressed parallel to their respective spring axis Xi, and support the first heating plate 42 and the second heating plate 46 so as to be movable in a direction parallel to the stroke direction H. The spring axes Xi are thus preferably orientated parallel to the stroke direction H.

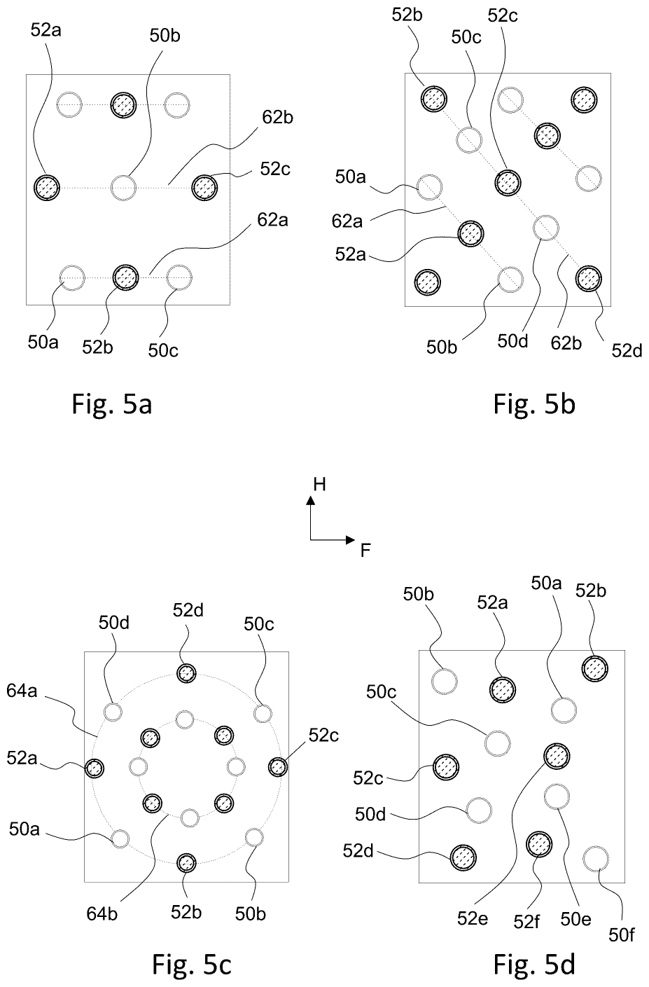

As further illustrated in FIGS. 3 and 4, it is generally advantageous when a first spring element 50a, 50b and a second spring element 52a, 52b, 52c are always arranged alternately in the conveying direction F and/or in the transverse direction Q. Further advantageous arrangements of the plurality of first spring elements 50a, 50b and of the plurality of second spring elements 52a, 52b, 52c are described with reference to FIG. 5a-d.

So that the first heating plate 42 and the second heating plate 46 can be deformed well and, at the same time, the best possible heat transfer to the forming film 6 is made possible, the first heating plate 42 preferably comprises a first transfer element 54 for transferring heat to the forming film 6 and a first heater or heating means 56 for heating the first transfer element 54. Accordingly, the second heating plate 46 preferably comprises a second transfer element 58 for transferring heat to the forming film 6 and a second heater or heating means 60 for heating the second transfer element 58.

The first transfer element 54 and the second transfer element 58 preferably have an substantially plate-shaped design in order to contact the forming film 6 in a flat manner, and can be formed by a metal plate, in particular made of aluminum or an aluminum alloy. The respective surface of the first transfer element 54 and of the second transfer element 58 facing the forming film 6 forms a working surface 54a, 58a of the transfer elements 54, 58.

The first heating means 56 can be arranged on a rear side of the first transfer element 54, which lies opposite the working surface 54a of the first transfer element 54 and can be in direct contact with the same. The second heating means 60 can be arranged on a rear side of the second transfer element 58, which lies opposite the working surface 58a of the second transfer element 58 and can be in contact with the same. The first and the second heating means 56, 60 are preferably formed as mica plate heating elements. In this way, the first and the second transfer element 54, 58 can be formed to be sufficiently thin for an elastic deformation, while they can be heated evenly and transfer the heat well to the forming film 6.

It is furthermore advantageous when the first heating plate 42 and the second heating plate 46 each comprise a plurality of segments 421, 422, 423, 461, 462, 463. As can be seen in FIG. 2, here the first heating plate 42 comprises three segments 421, 422, 423 and the second heating plate 46 comprises three segments 461, 462, 463, which are each arranged one behind the other in the conveying direction F. In this case, the first and the second heating plate 42, 46 are physically divided, so that the first heating plate 42 comprises a plurality of first transfer elements 54 and a plurality of first heating means 56, and the second heating plate 46 comprises a plurality of second transfer elements 58 as well as a plurality of second heating means 60. Each pair of a transfer element 54, 58 and a heating means 56, 60 can form a segment of the first or of the second heating plate 42, 46, respectively. Each segment of the plurality of segments 421, 422, 423, 461, 462, 463 is mounted by means of spring elements, wherein 4 to 5 spring elements are preferably provided in each segment.

Different arrangements of the plurality of first spring elements 50 and of the plurality of second spring elements 52 are described below with reference to FIG. 5a-d on the basis of a top view or projection, respectively, of the spring elements into a projection plane, which is perpendicular to the spring axes Xi.

In the embodiment illustrated in FIG. 5a and FIG. 5b, the spring elements of the plurality of first spring elements 50a, 50b, 50c, 50d and of the plurality of second spring elements 52a, 52b, 52c, 52d are arranged along a plurality of straight lines 62a, 62b. As shown, it is preferred that a first spring element 50a, 50b, 50c, 50d and a second spring element 52a, 52b, 52c, 52d are always arranged alternately along a respective line 62a, 62b. The plurality of lines 62a, 62b can be arranged parallel to each other, and parallel to the conveying direction F (see FIG. 5a), parallel to the transverse direction Q (not shown) or obliquely to the conveying direction F (see FIG. 5b). Alternatively, the lines can be curved instead of straight, for example.

In the embodiment shown in FIG. 5c, the spring elements of the plurality of first spring elements 50a, 50b, 50c, 50d and of the plurality of second spring elements 52a, 52b, 52c, 52d are arranged along a plurality of circular lines 64a, 64b. Here, it is also preferred that a first spring element 50a, 50b, 50c, 50d and a second spring element 52a, 52b, 52c, 52d are always arranged alternately along a respective line 64a, 64b. The plurality of lines 64a, 64b can be aligned concentrically, as illustrated. Alternatively, the lines can be elliptical instead of circular, for example.

Lastly, an embodiment is illustrated in FIG. 5d, in which the plurality of first spring elements 50a, 50b, 50c, 50d and the plurality of second spring elements 52a, 52b, 52c, 52d are positioned without any apparent order. Due to the arbitrary arrangement of the spring elements, they can be arranged individually where unevennesses appear, for example, due to manufacturing or loads on the heating plates and where a certain deformation is desired. Arbitrary deformations can thus further be generated in order to ensure a flat abutment of the heating plates 42, 46 against the forming film 6 in each individual case.

A heating device, a packaging machine comprising such a heating device as well as a method for operating such a packaging machine are provided, which effect an elastic deformation of the heating plates by means of a spring-loaded mounting of the heating plates by spring elements, which are spaced apart from each other and which thus provide for a flat abutment and thus an optimal heat transfer to the forming film even in the case of unevenness of the heating plates. Further embodiments are apparent for the person skilled in the art based on the detailed description of preferred exemplary embodiments included herein.

1. A heating device for heating a forming film, comprising:
a first tool comprising a first mount and a first heating plate, is the first tool being mounted on the first mount by way of a plurality of first spring elements; and
a second tool comprising a second mount and a second heating plate, is the second tool being mounted on the second mount by way of a plurality of second spring elements;

2. The heating device of claim 1, wherein the plurality of first spring elements and the plurality of second spring elements are formed and arranged in such a way that the first heating plate and the second heating plate are elastically deformed in a closed state of the first and the second tool.

3. The heating device of claim 1, wherein the plurality of first spring elements and the plurality of second spring elements are arranged along at least one straight line.

4. The heating device of claim 3, wherein a first spring element of the plurality of first spring elements and a second spring element of the plurality of second spring elements are arranged alternately along the at least one straight line.

5. The heating device of claim 1, wherein the plurality of first spring elements and the plurality of second spring elements are arranged along at least one circular line.

6. The heating device of claim 5, wherein a first spring element of the plurality of first spring elements and a second spring element of the plurality of second spring elements are arranged alternately along the at least one circular line.

7. The heating device of claim 1, wherein the plurality of first spring elements comprises between 2 and 30 first spring elements, and the plurality of second spring elements comprises between 2 and 30 second spring elements.

8. The heating device of claim 1, wherein the plurality of first spring elements and the plurality of second spring elements are formed by compression springs.

9. The heating device of claim 1, wherein the first heating plate comprises at least one first transfer element for contacting the forming film and at least one first heater for heating the at least one first transfer element, and the second heating plate comprises at least one second transfer element for contacting the forming film and at least one second heater for heating the at least one second transfer element.

10. The heating device of claim 9, wherein the at least one first transfer element and the at least one second transfer element comprise a metal plate.

11. The heating device of claim 9, wherein the at least one first transfer element and the at least one second transfer element each have a thickness between 1 mm and 15 mm.

12. The heating device of claim 1, wherein the first heating plate and the second heating plate comprises a plurality of segments.

13. The heating device of claim 1, wherein the first mount has a plurality of first recesses, wherein one spring element of the plurality of first spring elements is received in each of the plurality of first recesses, and the first heating plate comprises a plurality of first receiving elements, wherein one spring element of the plurality of first spring elements is mounted on each of the plurality of first receiving elements.

14. The heating device of claim 1, wherein the second mount has a plurality of second recesses, wherein one spring element of the plurality of second spring elements is received in each of the plurality of second recesses, and the second heating plate comprises a plurality of second receiving elements, wherein one spring element of the plurality of second spring elements is mounted on each of the plurality of second receiving elements.

15. A packaging machine comprising the heating device of claim 1.

16. A method for operating the packaging machine of claim 15 comprising the steps of:
arranging a section of the forming film between the first tool and the second tool in an open state of the first tool and of the second tool;
deformed;

17. The heating device of claim 1, wherein the plurality of first spring elements and the plurality of second spring elements are formed by helical springs.

18. The heating device of claim 9, wherein the at least one first transfer element and the at least one second transfer element each have a thickness between 2 mm and 10 mm.
